(19) United States
(12) Patent Application Publication
(10) Pub. No.: US 2025/0180776 A1
(43) Pub. Date: Jun. 5, 2025

(54) SYSTEM AND METHOD FOR DETERMINING HYDRAULIC FRACTURE GEOMETRY

(71) Applicant: CHEVRON U.S.A. INC., San Ramon, CA (US)

(72) Inventors: Yunhui TAN, Houston, TX (US); Jiehao WANG, Missouri City, TX (US); Han Young PARK, Katy, TX (US); Jaewoo AN, Houston, TX (US); Baosheng LIANG, Houston, TX (US); Oscar G. BELTRAN, Houston, TX (US); Yuguang CHEN, Bellaire, TX (US); Shahzad Ali KHAN, Katy, TX (US); Margaretha Catharina Maria RIJKEN, Houston, TX (US)

(73) Assignee: CHEVRON U.S.A. INC., San Ramon, CA (US)

(21) Appl. No.: 18/527,224

(22) Filed: Dec. 1, 2023

(51) Int. Cl. G01V 20/00; E21B 43/26; E21B 49/00

(52) U.S. Cl. CPC G01V 20/00; E21B 49/00; E21B 43/26; E21B 2200/20; E21B 2200/22

(57) ABSTRACT

A method is described for determining hydraulic fracture geometry. The method may be executed by a computer system. The method include training a first model that predicts a hydraulic fracture height for a hydraulic fracture using a first convolution neural network. The method includes training a second model that predicts a hydraulic fracture geometry for the hydraulic fracture using a second convolution neural network, the predicted hydraulic fracture height from the first trained model. Hydraulic fracture geometry may be determined for a target hydraulic fracture using the first and second trained models.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The disclosed embodiments relate generally to techniques for determining fracture geometry.

### BACKGROUND

Hydraulic fractures created through hydraulic fracturing may contribute to the viability and successful production of subsurface resources, such as hydrocarbons, from a subsurface formation. However, with vertical and lateral heterogeneity of rock properties, there may be some uncertainty regarding hydraulic fracture geometry. There exists a need for determining hydraulic fracture geometry.

### SUMMARY

In accordance with some embodiments, a method of determining hydraulic fracture geometry is disclosed. The method includes obtaining data for a subsurface formation. The obtained data comprises horizontal minimum stress data for a depth interval of interest, leakoff coefficient data for the depth interval of interest, plane strain Young's modulus data for the depth interval of interest, fracture fluid pumping volume data, fracture fluid pumping rate data, and fracturing fluid viscosity data. The method includes generating hydraulic fracturing simulation data by running a plurality of hydraulic fracturing simulations using the minimum horizontal stress data for the depth interval of interest, the leakoff coefficient data for the depth interval of interest, the plane strain Young's modulus data for the depth interval of interest, the fracture fluid pumping volume data, the fracture fluid pumping rate data, and the fracturing fluid viscosity data. The hydraulic fracturing simulation data comprises a plurality of simulated fracture heights and a plurality of fracture geometries. The method includes transforming the minimum horizontal stress data for a depth interval of interest into transformed minimum horizontal stress data by removing minimum horizontal stress at a perforation and removing hydrostatic pressure. The method includes transforming the leakoff coefficient data into transformed leakoff coefficient data by performing a logarithm transformation. The method includes training a first model that predicts a hydraulic fracture height for a hydraulic fracture using a first convolution neural network, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data. The method includes training a second model that predicts a hydraulic fracture geometry for the hydraulic fracture using a second convolution neural network, the predicted hydraulic fracture height from the first trained model, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data.

In accordance with some embodiments, a computer system, comprising: one or more processors; memory; and one or more programs. The one or more programs are stored in the memory and configured to be executed by the one or more processors, the one or more programs including instructions that when executed by the one or more processors cause the system to determine hydraulic fracture geometry. The method includes obtaining data for a subsurface formation. The obtained data comprises horizontal minimum stress data for a depth interval of interest, leakoff coefficient data for the depth interval of interest, plane strain Young's modulus data for the depth interval of interest, fracture fluid pumping volume data, fracture fluid pumping rate data, and fracturing fluid viscosity data. The method includes generating hydraulic fracturing simulation data by running a plurality of hydraulic fracturing simulations using the minimum horizontal stress data for the depth interval of interest, the leakoff coefficient data for the depth interval of interest, the plane strain Young's modulus data for the depth interval of interest, the fracture fluid pumping volume data, the fracture fluid pumping rate data, and the fracturing fluid viscosity data. The hydraulic fracturing simulation data comprises a plurality of simulated fracture heights and a plurality of fracture geometries. The method includes transforming the minimum horizontal stress data for a depth interval of interest into transformed minimum horizontal stress data by removing minimum horizontal stress at a perforation and removing hydrostatic pressure. The method includes transforming the leakoff coefficient data into transformed leakoff coefficient data by performing a logarithm transformation. The method includes training a first model that predicts a hydraulic fracture height for a hydraulic fracture using a first convolution neural network, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data. The method includes training a second model that predicts a hydraulic fracture geometry for the hydraulic fracture using a second convolution neural network, the predicted hydraulic fracture height from the first trained model, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data.

In accordance with some embodiments, a method of determining hydraulic fracture geometry is disclosed. The method includes obtain target data for a target hydraulic fracture; determine a hydraulic fracture height for the target hydraulic fracture using a first trained model and the obtained target data for the target hydraulic fracture; and determine a hydraulic fracture geometry for the target hydraulic fracture using a first trained model, the obtained target data for the target hydraulic fracture, and the determined hydraulic fracture height for the target hydraulic fracture. The first trained model and the second trained model are trained as follows: obtaining data for the subsurface formation. The obtained data comprises horizontal minimum stress data for a depth interval of interest, leakoff coefficient data for the depth interval of interest, plane strain Young's modulus data for the depth interval of interest, fracture fluid pumping volume data, fracture fluid pumping rate data, and fracturing fluid viscosity data. The first trained model and the second trained model are trained as follows: generating hydraulic fracturing simulation data by running a plurality of hydraulic fracturing simulations using the minimum horizontal stress data for the depth interval of interest, the leakoff coefficient data for the depth interval of interest, the plane strain Young's modulus data for the depth interval of interest, the fracture fluid pumping volume data, the fracture fluid pumping rate data, and the fracturing fluid viscosity data. The hydraulic fracturing simulation data comprises a plurality of simulated fracture heights and a plurality of fracture geometries. The first trained model and the second trained model are trained as follows: transforming the minimum horizontal stress data for a depth interval of interest into transformed minimum horizontal stress data by removing minimum horizontal stress at a perforation and removing hydrostatic pressure. The first trained model and the second trained model are trained as follows: transforming the leakoff coefficient data into transformed leakoff coefficient data by performing a logarithm transformation. The first trained model and the second trained model are trained as follows: training the first model that predicts a hydraulic fracture height for a hydraulic fracture using a first convolution neural network, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data. The first trained model and the second trained model are trained as follows: training the second model that predicts a hydraulic fracture geometry for the hydraulic fracture using a second convolution neural network, the predicted hydraulic fracture height from the first trained model, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1A illustrates a field system, including a wellbore, with which example embodiments may be used.

FIGS. 1B-1, 1B-2, and 1B-3 illustrates detailed view of FIG. 1A according to certain example embodiments.

FIG. 1C shows a detail of a hydraulic fracture of FIG. 1A.

FIG. 2 illustrates a computer system for determining hydraulic fracture geometry according to certain example embodiments.

FIG. 3 illustrates an example process 300 for determining hydraulic fracture geometry.

FIG. 4 illustrates a non-limiting example of hydraulic fracturing simulation data.

FIG. 5 illustrates a non-limiting example of training a first model according to certain example embodiments.

FIG. 6 illustrates a non-limiting example of training a second model according to certain example embodiments.

FIGS. 7A, 7B, and 7C illustrate good correspondence between the hydraulic fracture height predictions and the simulation-based ground truths for the following examples: the hydraulic fractureA, the hydraulic fractureB, and the hydraulic fractureC.

FIGS. 8A, 8B, and 8C illustrate good correspondence between the fracture geometry predictions and the simulation-based ground truths for the following examples: the hydraulic fractureA, the hydraulic fractureB, and the hydraulic fracture.

FIGS. 9A, 9B, 9C, and 9D illustrate comparisons (blind tests) for thousands of cases, which indicate reasonable match between predictions and simulation-based ground truths for both predicted hydraulic fracture heights and predicted fracture geometries according to certain example embodiments.

Like reference numerals refer to corresponding parts throughout the drawings.

### DETAILED DESCRIPTION OF EMBODIMENTS

Described below are methods and systems that provide a manner of determining fracture geometry. Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

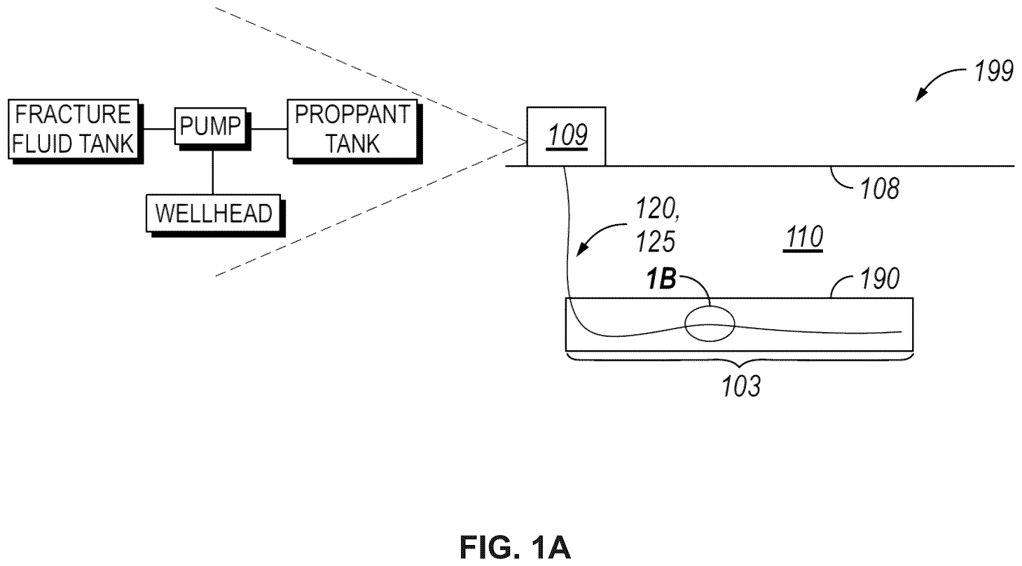

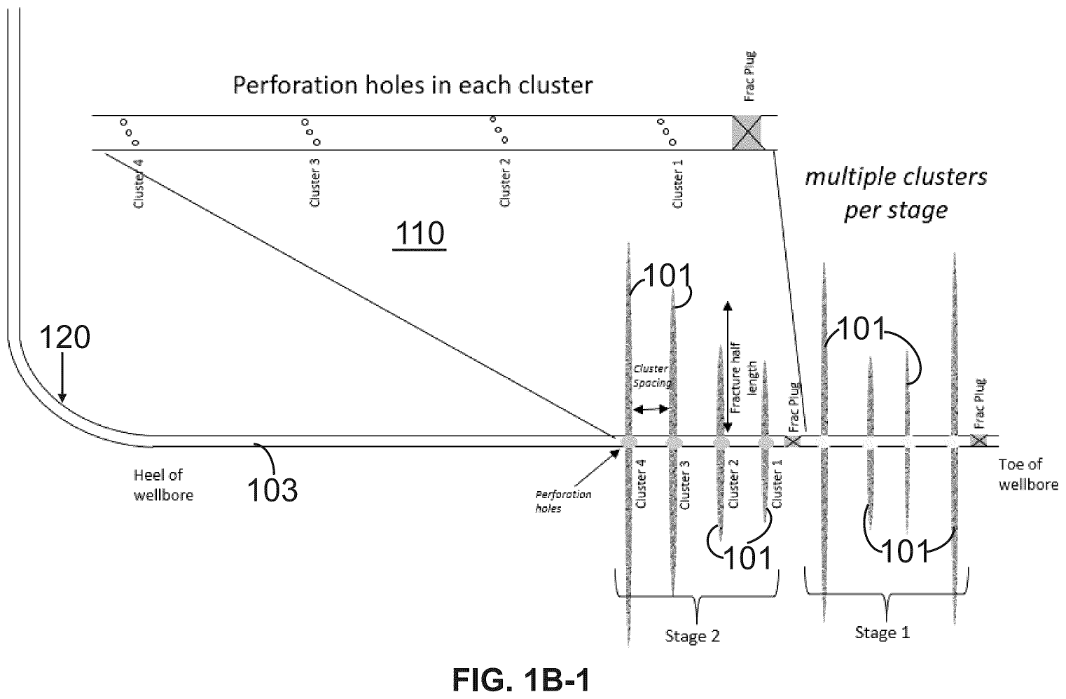

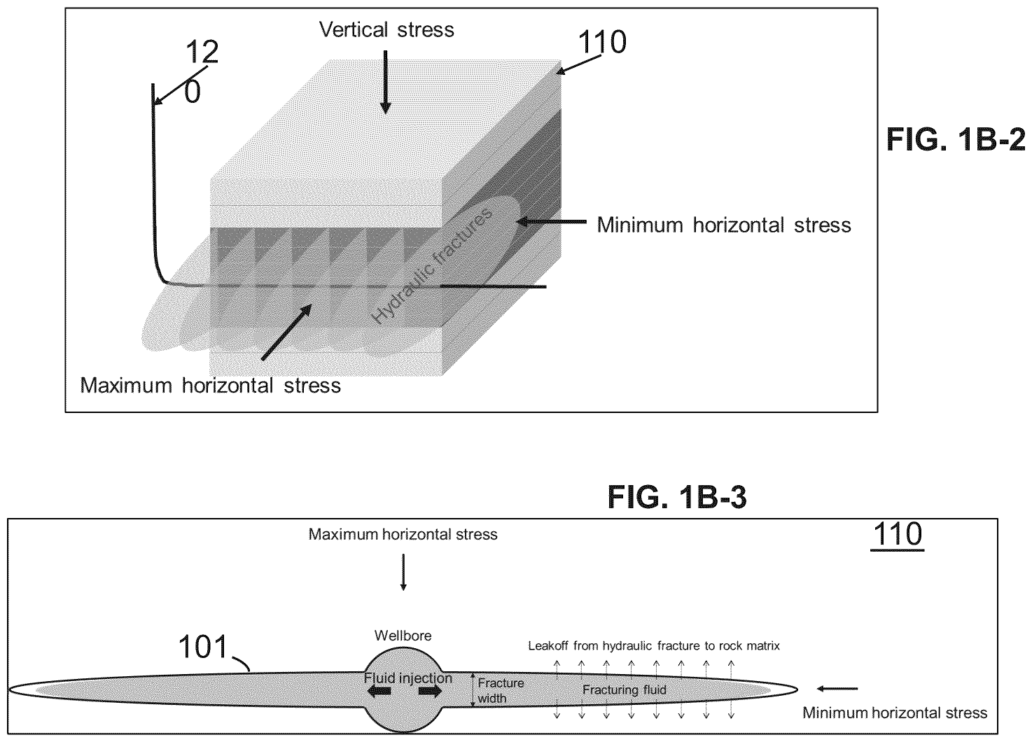

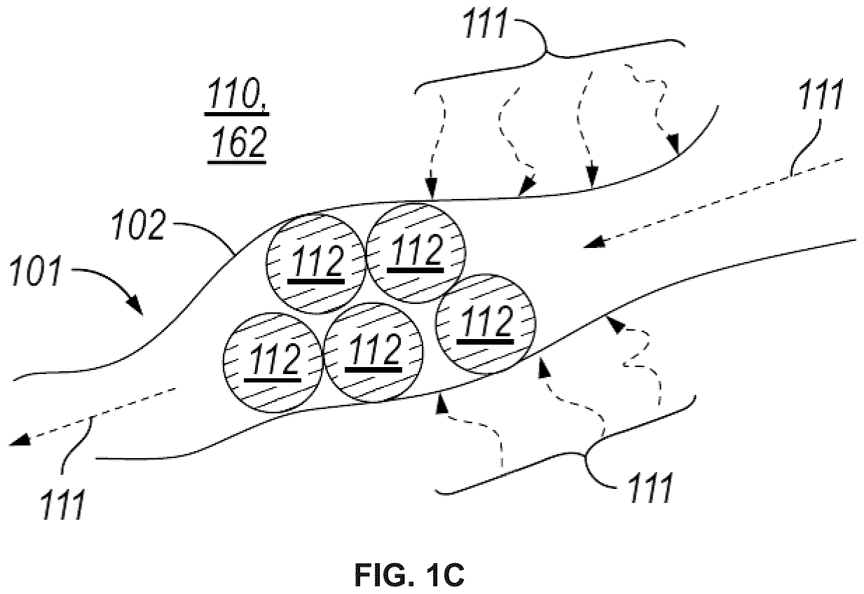

FIG. 1A shows a field system 199 with which example embodiments may be used. For simplicity, a single wellbore 120 drilled into a subsurface formation is illustrated in FIG. 1A. Hydraulic fracturing may be performed via the single wellbore 120. However, a plurality of wellbores may be drilled into a subsurface formation, and hydraulic fracturing may be performed via the plurality of wellbores.

Specifically, FIG. 1A shows a schematic diagram of a land-based field system 199 in which a wellbore 120 has been drilled in a subsurface formation 110 and may be utilized for hydraulic fracturing. The wellbore 120 of FIG. 1A starts out as substantially vertical, and then has a substantially horizontal section 103. FIGS. 1B-1, 1B-2, and 1B-3 show a detail of a substantially horizontal section 103 of the wellbore 120 of FIG. 1A. FIG. 1C shows a detail of a fracture 101 of FIGS. 1B-1 and 1B-3. The field system 199 of FIG. 1A may include field equipment 109 (e.g., a derrick, a tool pusher, a clamp, a tong, drill pipe, casing pipe, a drill bit, a wireline tool, a fluid pumping system, a wellhead, a tank (e.g., a fracture fluid tank and/or a proppant tank), a pump, etc.) located above a surface 108 and/or within the wellbore 120. Example embodiments may be applied to practically any wellbore of any configuration (e.g., wellbore with a substantially horizontal section as in FIG. 1A) in which hydraulic fracturing may be performed.

With respect to the system 199 of FIG. 1A, once the wellbore 120 is drilled, a casing string 125 is inserted into the wellbore 120 to stabilize the wellbore 120 and allow for the extraction of subsurface resources (e.g., natural gas, oil, produced water) from the subsurface formation 110. Field equipment 109, located at the surface 108, is used to drill, encase, fracture, produce, and/or perform any other part of a field operation with respect to the wellbore 120.

The surface 108 may be ground level for an onshore application and the sea floor (or other similar floor under a body of water) for an offshore application. A body of water may include, but it not limited to, sea water, brackish water, flowback or produced water, wastewater (e.g., reclaimed or recycled), brine (e.g., reservoir or synthetic brine), fresh water (e.g., fresh water comprises <1,000 ppm TDS), any other type of water, or any combination thereof. For offshore applications, at least some of the field equipment may be located on a platform that sits above the water level. The point where the wellbore 120 begins at the surface 108 may include a wellhead.

While the subsurface formation 110 may have naturally-occurring fractures and some fractures that may have been created when drilling the wellbore 120, these fractures may need to be enlarged and elongated, and additional fractures may need to be created, in order to extract additional subsurface resources 111 (e.g., oil, natural gas) from the subsurface formation 110. In such cases, hydraulic fracturing processes may be utilized to accomplish these goals. The fractures 101 are shown to be located in the horizontal section 103 of the wellbore 120 in FIGS. 1B-1 and 1B-3. Each fracture 101 may have a corresponding hydraulic fracture height and a hydraulic fracture geometry.

The subsurface formation 110 may include one or more of a number of formation types, including but not limited to shale, limestone, sandstone, clay, sand, and salt. In certain embodiments, a subsurface formation 110 may include one or more reservoirs in which one or more resources (e.g., oil, natural gas, water) may be located. One or more of a number of field operations (e.g., fracturing, coring, tripping, drilling, setting casing, extracting downhole resources) may be performed to reach an objective of a user with respect to the subsurface formation 110.

The wellbore 120 may have one or more of a number of portions or hole portions, where each portion or hole portion may have one or more of a number of dimensions. Examples of such dimensions may include, but are not limited to, a size (e.g., diameter) of the wellbore 120, a curvature of the wellbore 120, a total vertical depth of the wellbore 120, a measured depth of the wellbore 120, and a horizontal displacement of the wellbore 120. There may be multiple overlapping casing strings of various sizes (e.g., length, outer diameter) contained within and between these portions or hole portions to ensure the integrity of the wellbore construction. In this case, one or more of the portions of the subsurface wellbore 120 is the substantially horizontal section 103.

As discussed above, inserted into and disposed within the wellbore 120 of FIGS. 1A and FIGS. 1B-1, 1B-2, and 1B-3 are a number of casing pipes that are coupled to each other end-to-end to form the casing string 125. In this case, each end of a casing pipe has mating threads (a type of coupling feature) disposed thereon, allowing a casing pipe to be directly or indirectly mechanically coupled to another casing pipe in an end-to-end configuration. The casing pipes of the casing string 125 may be indirectly mechanically coupled to each other using a coupling device, such as a coupling sleeve.

Each casing pipe of the casing string 125 may have a length and a width (e.g., outer diameter). The length of a casing pipe may vary. For example, a common length of a casing pipe is approximately 40 feet. The length of a casing pipe may be longer (e.g., 60 feet) or shorter (e.g., 10 feet) than 40 feet. The width of a casing pipe may also vary and may depend on the cross-sectional shape of the casing pipe. For example, when the shape of the casing pipe is cylindrical, the width may refer to an outer diameter, an inner diameter, or some other form of measurement of the casing pipe. Examples of a width in terms of an outer diameter may include, but are not limited to, 4½ inches, 7 inches, 7⅝ inches, 8⅝ inches, 10¾ inches, 13⅜ inches, and 14 inches.

The size (e.g., width, length) of the casing string 125 may be based on the information (e.g., diameter of the borehole drilled) gathered using field equipment with respect to the wellbore 120. The walls of the casing string 125 and the casing string 225 have an inner surface that forms a cavity that traverses the length of the casing string 125. Each casing pipe may be made of one or more of a number of suitable materials, including but not limited to steel. Cement is poured into the wellbore 120 through the cavity and then forced upward between the outer surface of the casing string 125 and the wall of the wellbore 120. In some cases, a liner may additionally be used with, or alternatively be used in place of, some or all of the casing pipes.

Referring to FIGS. 1A, 1B-1, 1B-2, and 1B-3, and IC, once the cement dries and cures, a number of fractures 101 may be created in the subsurface formation 110. The fractures 101 may be created in any of a number of ways known in the industry, including but not limited to hydraulic fracturing. The hydraulic fracturing process involves the injection of fracturing fluid and proppant 112 (e.g., sand, ceramic pellets) into the subsurface formation 110 from the wellbore 120 to create fracture networks. Even if a subsurface formation 110 naturally has fractures 101, these naturally occurring fractures 101 have inconsistent characteristics (e.g., length, spacing) and so in some cases cannot be relied upon for extracting subsurface resources without having additional fractures 101, such as what is shown in FIGS. 1B-1 and 1B-3, created in the subsurface formation 110 such as through hydraulic fracturing.

Hydraulic fracturing may entail preparing an injection fluid (oftentimes referred to a fracturing fluid) and injecting that fracturing fluid into the wellbore 120 at a sufficient rate and pressure to open existing fractures and/or create fractures in the subsurface formation 110. The fractures 101 permit hydrocarbons to flow more freely into the wellbore 120. The fracturing fluid may also include proppant 112. The proppant 112, such as sand or other particles, are meant to hold the fractures 101 open so that hydrocarbons can more easily flow to the wellbore 120. The fracturing fluid and the proppant 112 may be stored in separate tanks and blended together using at least one blender (not shown). The fracturing fluid may also include other components in addition to the proppant 112.

More specifically, the wellbore 120 and the subsurface formation 110 proximate to the wellbore 120 are in fluid communication (e.g., via perforations such as in FIGS. 1B-1 and 1B-3), and the fracturing fluid with the proppant 112 is injected into the wellbore 120 into the subsurface formation 110 through a wellhead of the wellbore 120 using at least one pump (oftentimes called a fracturing pump). The fracturing fluid with the proppant 112 is injected at a sufficient rate and pressure to open existing fractures and/or create fractures in the subsurface formation 110. As fractures become sufficiently wide to allow proppant 112 to flow into those fractures 101, proppant 112 in the fracturing fluid are deposited in those fractures 101 during injection of the fracturing fluid. After the hydraulic fracturing process is completed, the fracturing fluid is removed by flowing or pumping it back out of the wellbore 120 as the wellbore 120 is put on production, such that the fracturing fluid does not block the flow of hydrocarbons to the wellbore 120. The hydrocarbons may enter the same wellbore 120 (or another wellbore that is drilled into the subsurface formation 110) from the subsurface formation 110 and go up to the surface 108 for further processing.

As shown in FIG. 1C, the proppant 112 is designed to become lodged inside at least some of the fractures 101 to keep those fractures 101 open after the fracturing operation is complete so that produced fluid containing subsurface resources 111 (e.g., hydrocarbons) can flow through the fractures 101 to the wellbore 120. Sizes (e.g., 40/70 mesh, 50/140 mesh) of the proppant 112 may vary. While the shape of the proppant 112 is shown as being uniformly spherical, and the size is substantially identical among the proppant 112, the actual sizes and shapes of the proppant 112 may vary. If the proppant 112 is too small, the proppant 112 will not be effective at keeping the fractures 101 open enough to effectively allow produced fluid containing subsurface resources 111 (e.g., hydrocarbons) to flow through the fractures 101 from the rock matrices 162 in the subsurface formation 110 to the wellbore 120. If the proppant 112 is too large, the proppant 112 may plug up the fractures 101, blocking the flow of the produced fluid containing subsurface resources 111 through the fractures 101. During hydraulic fracturing, the fluid flows in the opposite direction shown in FIG. 1C.

The use of proppant 112 in certain types of subsurface formations 110, such as shale, is useful. Shale formations typically have permeabilities on the order of microdarcys (μD) to nanodarcys (nD). When fractures 101 are created in such formations with low permeabilities, it is useful to sustain the fractures 101 and their permeability and conductivity for an extended period of time in order to extract more of the subsurface resources 111.

The created fractures 101 may be spaced a distance 192 apart from each other by using stages in the hydraulic fracturing process. For instance, as illustrated in FIGS. 1B-1, each stage may include a plurality of clusters, and each cluster may include a plurality of perforation holes. As also illustrated in FIGS. 1B-1 and 1B-3, fractures 101 may vary in length and/or height. Further, the created fractures 101 create a volume 190 within the subsurface formation 110 where the rock matrix 162 of the subsurface formation 110 is connected to the high conductivity fractures 101 located a short distance away.

Each fracture 101, whether created or naturally occurring, is defined by a wall 102, also called a frac face 102 herein. The frac face 102 provides a transition between the paths formed by the rock matrices 162 in the subsurface formation 110 and the fracture 101. The subsurface resources 111 flow through the paths formed by the rock matrices 162 in the subsurface formation 110 into the fracture 101.

In short, fractures created through hydraulic fracturing may contribute to the viability and successful production of subsurface resources from a subsurface formation. However, with vertical and lateral heterogeneity of rock properties, there may be some uncertainty regarding hydraulic fracture geometry.

Hydraulic fracturing simulators are sometimes used to optimize landing point, well spacing, completion design, and development strategy for unconventional oil and gas wellbores. Planar 3D hydraulic fracturing models are sometimes utilized for the formations with stresses or elastic properties varying non-monotonically as a function of depth or unconfined hydraulic fracture height growth. This type of model is more accurate than the PKN-like or pseudo 3D models, but it is much more computationally intensive as non-local elasticity equations are solved in 3D spaces. This may impede fast decision-making, especially when multiple wellbores/scenarios need to be evaluated in a short period. Thus, acceleration of planar 3D fracturing modeling is desired to fit the fast pace of unconventional resource development.

Advantageously, embodiments consistent with the instant disclosure may utilize deep-learning-based models that improve (e.g., significantly improve) planar 3D fracturing modeling efficiency, yet with decent accuracy and interpretability. Advantageously, embodiments consistent with the instant disclosure may quickly predict hydraulic fracture heights to constrain height growths of pseudo 3D models for pad-level hydraulic fracture network modeling. The predicted hydraulic fracture geometries based on the predicted hydraulic fracture heights may be used to efficiently optimize well landing depths and/or estimate vertical fracture-driven interaction.

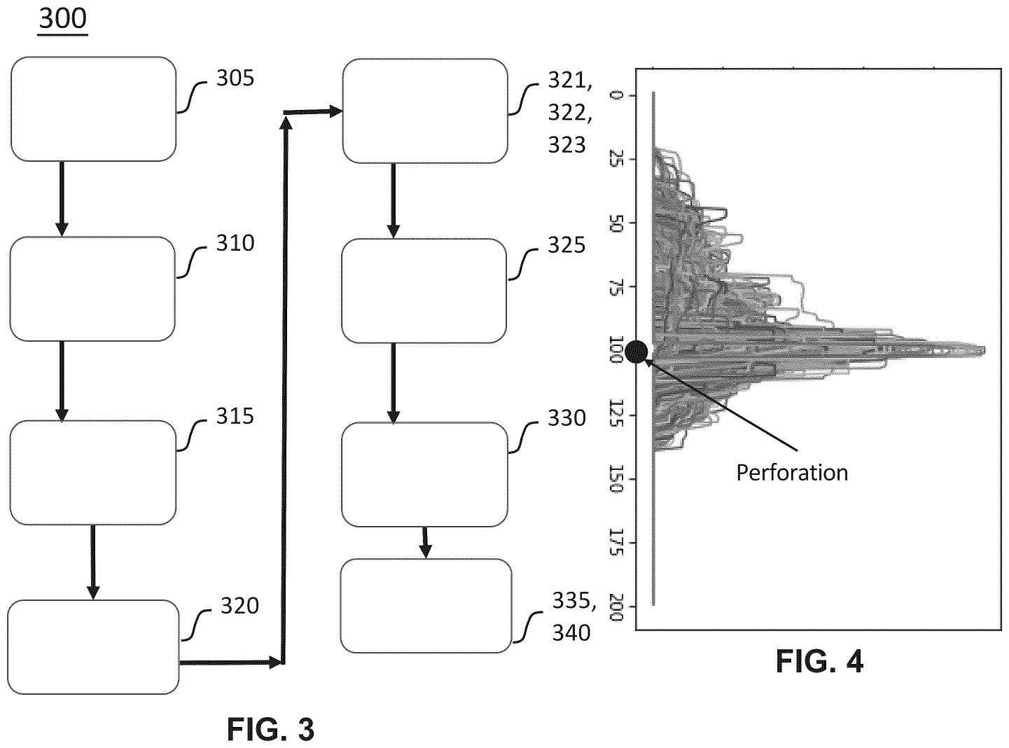

The methods and systems of the present disclosure may, in part, use one or more models that are machine-learning algorithms. These models may be supervised or unsupervised. Supervised learning algorithms are trained using labeled data (i.e., training data) which consist of input and output pairs. By way of example and not limitation, supervised learning algorithms may include classification and/or regression algorithms such as neural networks, generative adversarial networks, linear regression, etc. Unsupervised learning algorithms are trained using unlabeled data, meaning that training data pairs are not needed. By way of example and not limitation, unsupervised learning algorithms may include clustering and/or association algorithms such as k-means clustering, principal component analysis, singular value decomposition, etc. Although the present disclosure may name specific models, those of skill in the art will appreciate that any model that may accomplish the goal may be used. Training of a first model and a second model are discussed further herein, for example, in the context of FIG. 3.

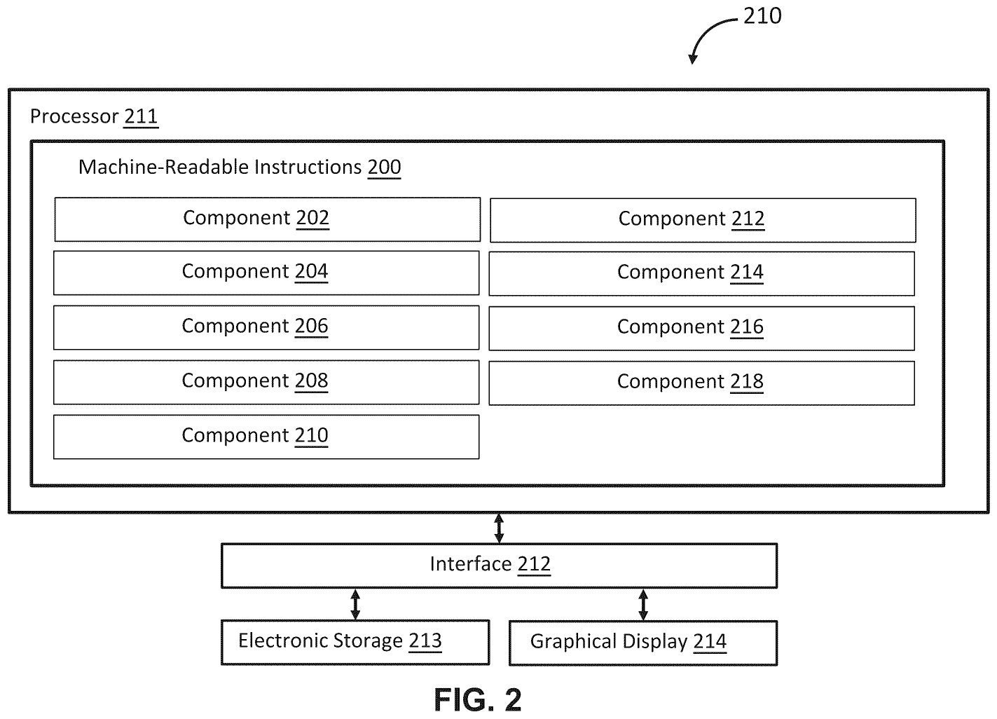

The methods and systems of the present disclosure may be implemented by a system and/or in a system, such as a system 10 shown in FIG. 2. The system 210 may include one or more of a processor 211, an interface 212 (e.g., bus, wireless interface), an electronic storage 213, a graphical display 214, and/or other components. Embodiments of a method of determining hydraulic fracture geometry are provided herein to be performed by the processor 211, including input such as data for a subsurface formation for training a first model and training a second model, simulation data for training a first model and training a second model, and/or target data for a target hydraulic fracture. The output may be a determined hydraulic fracture geometry for the target hydraulic fracture.

The electronic storage 213 may be configured to include electronic storage medium that electronically stores information. The electronic storage 213 may store software algorithms, information determined by the processor 211, information received remotely, and/or other information that enables the system 210 to function properly. For example, the electronic storage 213 may store information relating to input such as data for a subsurface formation for training a first model and training a second model, simulation data for training a first model and training a second model, target data for a target hydraulic fracture, and/or other information. For example, the electronic storage 213 may store information relating to output such as a determined hydraulic fracture geometry for a target hydraulic fracture, and/or other information. The electronic storage media of the electronic storage 213 may be provided integrally (i.e., substantially non-removable) with one or more components of the system 210 and/or as removable storage that is connectable to one or more components of the system 210 via, for example, a port (e.g., a USB port, a Firewire port, etc.) or a drive (e.g., a disk drive, etc.). The electronic storage 213 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 213 may include one or more non-transitory computer readable storage medium storing one or more programs. The electronic storage 213 may be a separate component within the system 210, or the electronic storage 213 may be provided integrally with one or more other components of the system 10 (e.g., the processor 211). Although the electronic storage 213 is shown in FIG. 2 as a single entity, this is for illustrative purposes only. In some implementations, the electronic storage 213 may comprise a plurality of storage units. These storage units may be physically located within the same device, or the electronic storage 213 may represent storage functionality of a plurality of devices operating in coordination.

The graphical display 214 may refer to an electronic device that provides visual presentation of information. The graphical display 214 may include a color display and/or a non-color display. The graphical display 214 may be configured to visually present information. The graphical display 214 may present information using/within one or more graphical user interfaces. For example, the graphical display 214 may present information relating to a first trained model for predicting/determining a hydraulic fracture height, a second trained model for predicting/determining a hydraulic fracture geometry, a predicted/determined hydraulic fracture height from a first trained model to be utilized for a second trained model, a predicted/determined hydraulic fracture height for a target hydraulic fracture, and/or other information. Display representations may be generated in some embodiments, and those display representations may be displayed via the display 214.

The processor 211 may be configured to provide information processing capabilities in the system 210. As such, the processor 211 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 211 may be configured to execute one or more machine-readable instructions 200 to facilitate determining hydraulic fracture geometry. The machine-readable instructions 200 may include one or more computer program components. The machine-readable instructions 200 may include a subsurface formation data component 202, a simulation data component 204, a minimum horizontal stress transformation component 206, a leakoff coefficient transformation component 208, a first model training component 210, a second model training component 212, a split component 214, a hydraulic fracture geometry determination component 216, a display component 218, and/or other computer program components.

It should be appreciated that although computer program components are illustrated in FIG. 2 as being co-located within a single processing unit, one or more of computer program components may be located remotely from the other computer program components. While computer program components are described as performing or being configured to perform operations, computer program components may comprise instructions which may program processor 211 and/or system 210 to perform the operation.

While computer program components are described herein as being implemented via processor 211 through machine-readable instructions 200, this is merely for case of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 200, the subsurface formation data component 202 may be configured to obtain data for a subsurface formation, wherein the obtained data comprises horizontal minimum stress data for a depth interval of interest, leakoff coefficient data for the depth interval of interest, plane strain Young's modulus data for the depth interval of interest, fracture fluid pumping volume data, fracture fluid pumping rate data, and fracturing fluid viscosity data.

The simulation data component 204 may be configured to generate hydraulic fracturing simulation data by running a plurality of hydraulic fracturing simulations using the minimum horizontal stress data for the depth interval of interest, the leakoff coefficient data for the depth interval of interest, the plane strain Young's modulus data for the depth interval of interest, the fracture fluid pumping volume data, the fracture fluid pumping rate data, and the fracturing fluid viscosity data. The hydraulic fracturing simulation data comprises a plurality of simulated fracture heights and a plurality of fracture geometries.

The minimum horizontal stress transformation component 206 may be configured to transform the minimum horizontal stress data for a depth interval of interest into transformed minimum horizontal stress data by removing minimum horizontal stress at a perforation and removing hydrostatic pressure.

The leakoff coefficient transformation component 208 may be configured to transform the leakoff coefficient data into transformed leakoff coefficient data by performing a logarithm transformation.

The first model training component 210 may be configured to train a first model that predicts a hydraulic fracture height for a hydraulic fracture using a first convolution neural network, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data. In some embodiments, the first convolutional neural network comprises a first U-Net.

The second model training component 212 may be configured to train a second model that predicts a hydraulic fracture geometry for the hydraulic fracture using a second convolution neural network, the predicted hydraulic fracture height from the first trained model, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data. In some embodiments, the second convolutional neural network comprises a second U-Net.

The split component 214 may be configured to split, before or after the transformation, the one-dimensional (1D) vector of the minimum horizontal stress data for the depth interval of interest into a plurality of one-dimensional (1D) vectors, wherein the plurality of one-dimensional (1D) vectors is utilized for training the first model and training the second model. The split component 214 may be configured to split, before or after the transformation, the one-dimensional (1D) vector of the leakoff coefficient data for the depth interval of interest into a plurality of one-dimensional (1D) vectors, wherein the plurality of one-dimensional (1D) vectors is utilized for training the first model and training the second model. The split component 214 may be configured to split the one-dimensional (1D) vector of the plane strain Young's modulus data for the depth interval of interest into a plurality of one-dimensional (1D) vectors, wherein the plurality of one-dimensional (1D) vectors is utilized for training the first model and training the second model.

The hydraulic fracture geometry determination component 216 may be configured to obtain target data for a target hydraulic fracture; determine a hydraulic fracture height for the target hydraulic fracture using the first trained model and the obtained target data for the target hydraulic fracture; and determine a hydraulic fracture geometry for the target hydraulic fracture using the second trained model, the obtained target data for the target hydraulic fracture, and the determined hydraulic fracture height for the target hydraulic fracture.

The display component 218 may be configured to display a hydraulic fracture geometry for a target hydraulic fracture.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 211 may be configured to execute one or more additional computer program components that may perform some or all of the functionality attributed to one or more of computer program components described herein.

FIG. 3 illustrates an example process 300 for determining hydraulic fracture geometry. A first trained model (e.g., a planar 3D model) may be developed based on deep learning to quickly predict a fracture height of a hydraulic fracture. A second trained model and a second trained model (e.g., a planar 3D model) may be developed based on deep learning and the first trained model (e.g., the first planar 3D model) to quickly predict a hydraulic fracture geometry for a target hydraulic fracture. The first and second trained models may employ deep convolutional neural networks, such as, U-Nets, and may be trained with high-fidelity planar 3D fracturing simulation results from thousands of cases.

At 305, the method 300 comprises obtaining data for the subsurface formation, wherein the obtained data comprises minimum horizontal stress data for a depth interval of interest, leakoff coefficient data for the depth interval of interest, plane strain Young's modulus data for the depth interval of interest, fracture fluid pumping volume data, fracture fluid pumping rate data, and fracturing fluid viscosity data.

Minimum horizontal stress, leakoff coefficient, and plane strain Young's modulus are parameters controlling fracture geometry. The minimum horizontal stress (Sₕₘᵢₙ) may be obtained from Mechanical Earth Models (MEMs) based on well log data. The leakoff coefficient may defined as follows:

$$C = \frac{2 {C}_{v} {C}_{c}}{{C}_{v} + \sqrt{{C}_{v}^{2} + 4 {C}_{c}^{2}}}$$

wherein Cis a leakoff coefficient, Cᵥ and C_{c} are two components of the leakoff coefficient that may be defined as follows:

$$\begin{matrix}{C}_{v} = \sqrt{\frac{k φΔ {p}_{v}}{2 {μ}_{f}}} \\ {C}_{c} = \sqrt{\frac{{kc}_{t} φ}{πμ} Δ {p}_{r}}\end{matrix}$$

wherein k is a rock matrix permeability, φ is a rock matrix porosity, Δpᵥ is a pressure drop across a filtrate zone, μ_{f} is a fracturing fluid viscosity, cₜ is a total compressibility, π is a mathematical constant, μ is a reservoir fluid viscosity, Δpᵣ is a pressure drop across a reservoir region. The filtrate zone and the reservoir region may be two different zones. The plain strain Young's modulus data may be defined as follows:

$${E}^{′} = \frac{E}{1 - {υ}^{2}} ,$$

wherein E is the Young's modulus and v is the Poisson's ratio. The minimum horizontal stress data may be obtained as a one-dimensional (1D) vector. Additionally, the leakoff coefficient may be obtained as a 1D vector. Additionally, the plane strain Young's modulus data may be obtained as a 1D vector. Thus, three 1D vectors may be obtained. The depth interval of interest may be obtained as user input from a user, such as via a graphical user interface. The depth interval of interest may be hundreds of feet, thousands of feet, etc. More information may be found in FIGS. 1B-2 and 1B-3.

Fracture fluid pumping volume, fracture fluid pumping rate, and fracturing fluid viscosity are parameters controlling fracture geometry. The fracture fluid pumping volume data, such as gallons (gal) per hydraulic fracture, may be obtained as a scalar. Additionally, the fracture fluid pumping rate data, such as barrels (bbl) per minute per hydraulic fracture, may be obtained as a scalar. Additionally, the fracturing fluid viscosity data, such as centipoise (cP), may be obtained as a scalar. The fracture fluid pumping volume data and/or the fracture fluid pumping rate data may be associated with at least wellbore drilled into the subsurface formation.

At 310, the method 300 comprises generating hydraulic fracturing simulation data by running a plurality of hydraulic fracturing simulations using the minimum horizontal stress data for the depth interval of interest, the leakoff coefficient data for the depth interval of interest, the plane strain Young's modulus data for the depth interval of interest, the fracture fluid pumping volume data, the fracture fluid pumping rate data, and the fracturing fluid viscosity data. The hydraulic fracturing simulation data comprises a plurality of simulated hydraulic fracture heights and a plurality of hydraulic fracture geometrics. A non-limiting example of hydraulic fracturing simulation data is illustrated in FIG. 4.

The hydraulic fracturing simulations may be physics based hydraulic fracturing simulations. The hydraulic fracturing simulations may involve solving governing equations for four coupled physical processes: rock deformation, fluid flow in matrix and fracture, fracture propagation, and proppant transport. The hydraulic fracturing simulations may include constructing at least one hydraulic fracturing model. The at least one hydraulic fracturing model may be a 3D model, such as, but not limited to, a Planar3D model. The at least one hydraulic fracturing model may be a 2D model, such as, but not limited to, a Perkins-Kern-Nordgren (PKN) model, a Kristianovich-Geertsma-de Klerk (KGD) model, a radial or a penny-shape fracture model, etc. The at least one hydraulic fracturing model may be a pseudo 3D model. The at least one hydraulic fracturing model may be a fully 3D model. There are many types of hydraulic fracturing simulators and/or models that may be utilized. As an example, hundreds to thousands of hydraulic fracturing simulation runs may be utilized at 320 to generate the hydraulic fracturing simulation data. As an example, if 1,000 hydraulic fracturing simulation runs were performed, then the hydraulic fracturing simulation data may include 1,000 pairs of simulated hydraulic fracture heights and simulated hydraulic fracture geometrics.

At 315, the method 300 comprises transforming the minimum horizontal stress data for a depth interval of interest into transformed minimum horizontal stress data by removing minimum horizontal stress at perforation and removing hydrostatic pressure. For example, the transformation may comprise subtracting minimum horizontal stress at perforation, which is data already in the 1D vector of minimum horizontal stress data. The transformation may also comprise subtracting hydrostatic pressure (e.g., pressure profile with a constant pressure gradient). A value of 0.433 psi per foot, which is hydrostatic pressure gradient of water, may be utilized. The 1D vector of transformed minimum horizontal stress data may then be utilized for the training at 325 and at 330.

As a non-limiting example, let's assume a 1D vector for the minimum horizontal stress that includes 200 elements representing the minimum horizontal stress along the depth interval of interest. And let's assume the minimum horizontal stress at a perforation corresponds to the 100th element in this 1D vector. The first step of the transformation is to subtract the 100th element from all the 200 elements in the 1D vector. Continuing with this example, let's construct a hydrostatic pressure profile which is also a 1D vector with 200 elements. Since the perforation's location corresponds to the 100th element, then set the 100th element of this hydrostatic pressure profile 1D vector to be zero. And then apply a constant pressure gradient of 0.433 psi per foot to obtain the other 199 elements in this hydrostatic pressure profile 1D vector. Continuing with this example, next, perform the second step of this transformation by subtracting this hydrostatic pressure profile 1D vector from the minimum horizontal stress 1D vector.

At 320, the method 300 comprises transforming the leakoff coefficient data into transformed leakoff coefficient data by performing a logarithm transformation. For the logarithm transformation, the logarithmic base may be 10 or Euler's number, but it may be other numbers. As an example, the logarithm transformation may be as follows: transformed leakoff coefficient=ln(leakoff coefficient). The 1D vector of transformed leakoff coefficient data may then be utilized for the training at 325 and at 330.

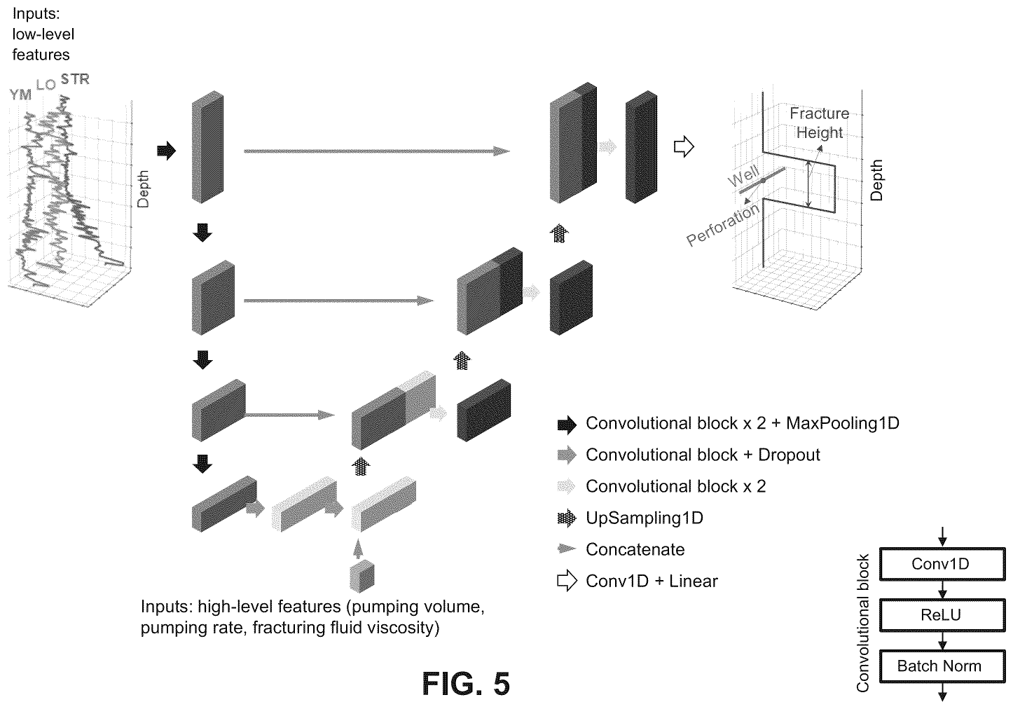

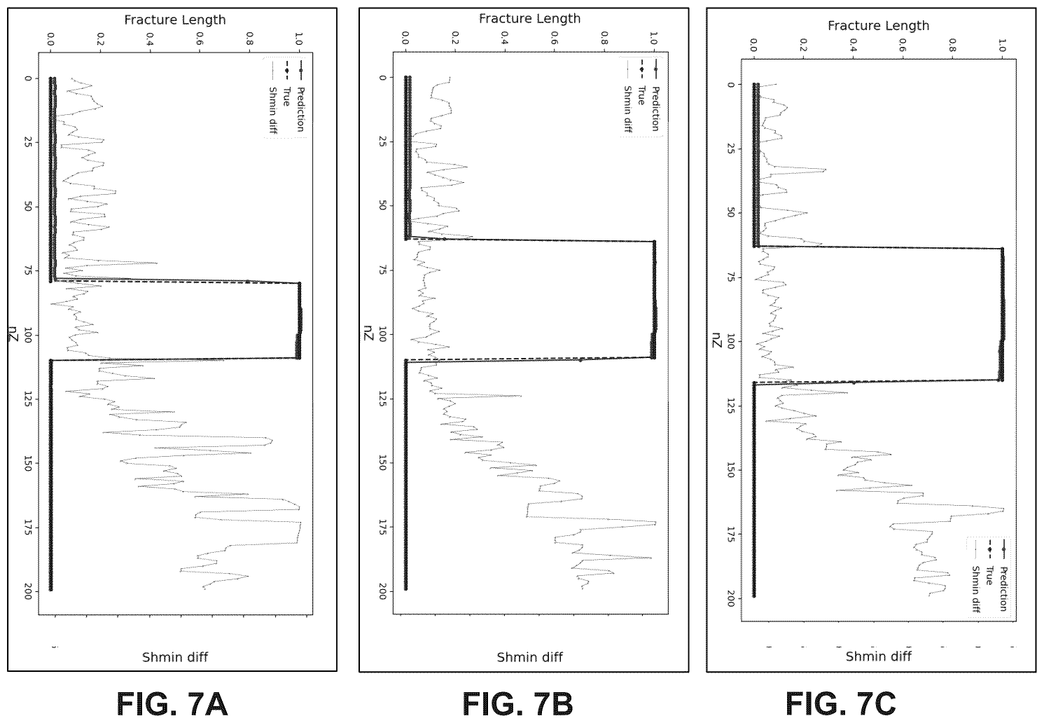

At 325, the method 300 comprises training a first model that predicts a hydraulic fracture height for a hydraulic fracture using a first convolution neural network using the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data. The first convulsion neural network may comprise a first U-Net. A non-limiting example of training the first model is illustrated in FIG. 5. Non-limiting examples of predicted/determined hydraulic fracture heights are illustrated in FIGS. 7A, 7B, and 7C. The abbreviations in FIG. 5 stand for the following: YM=Young modulus, LO=leakoff coefficient, and STR=stress.

In one embodiment, the three 1D vectors (e.g., the 1D vector of the transformed minimum horizontal stress data for the depth interval of interest, the 1D vector of the transformed leakoff coefficient data for the depth interval of interest, and the 1D vector of the plane strain Young's modulus data for the depth interval of interest) may be taken as low-level features in three channels into the first convolutional neural network, such as a first U-Net. The three scalars (e.g., the scalar of the fracture fluid pumping volume data, the scalar of the fracture fluid pumping rate data, and the scalar of fracturing fluid viscosity data) may be fed into the first convolutional neural network as high-level features at the bottleneck of the first convolutional neural network, such as at the bottleneck of the first U-Net. The simulation data (fracture height) may be fed into the first convolutional neural network as targets. The first trained model from the first convolutional neural network may be utilized to predict hydraulic fracture height, such as, predict hydraulic fracture height for a target hydraulic fracture.

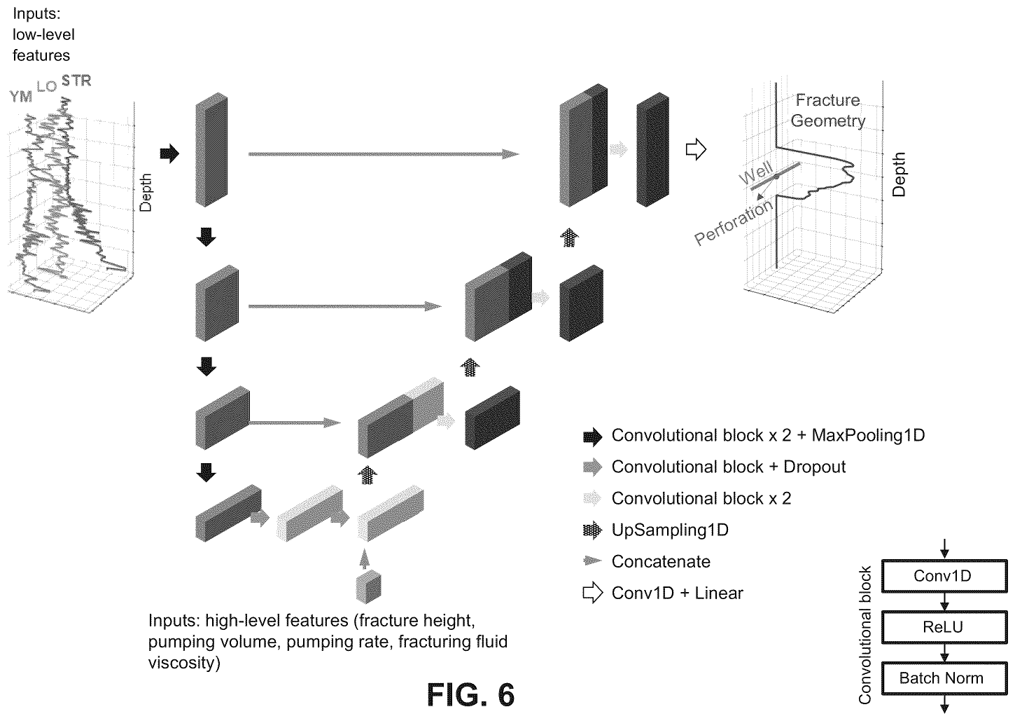

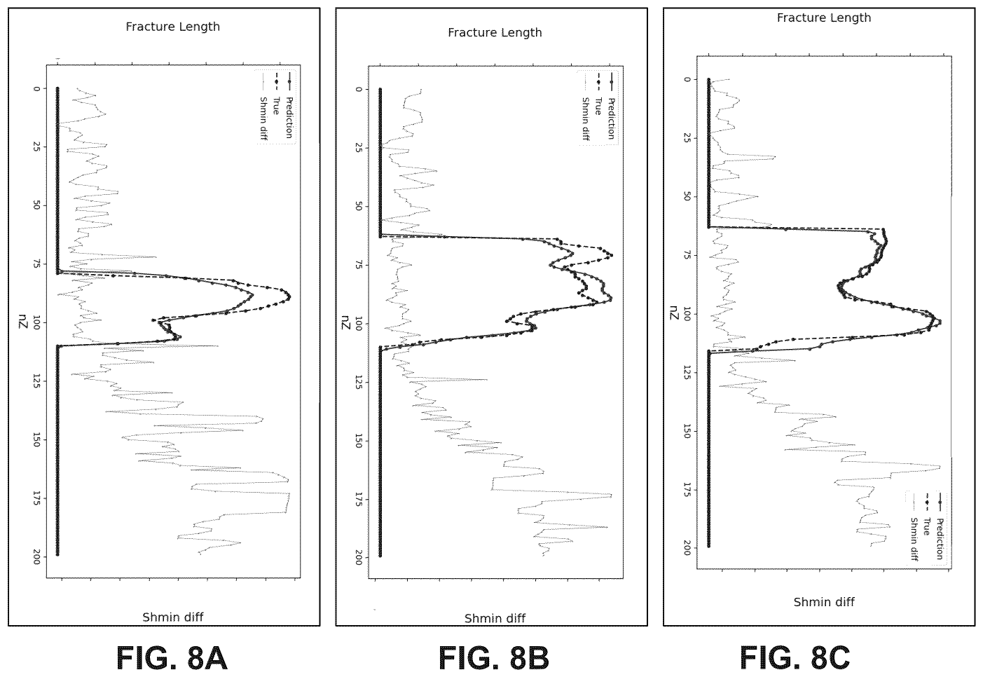

At 330, the method 300 comprises training a second model that predicts a hydraulic fracture geometry for the hydraulic fracture using a second convolution neural network, the predicted hydraulic fracture height from the first trained model, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data. The second convulsion neural network may comprise a second U-Net. A non-limiting example of training the second model is illustrated in FIG. 6. Non-limiting examples of predicted/determined hydraulic fracture geometries are illustrated in FIGS. 8A, 8B, and 8C. The abbreviations in FIG. 6 stand for the following: YM=plane strain Young's modulus, LO=leakoff coefficient, and STR=minimum horizontal stress.

In one embodiment, the three 1D vectors (e.g., the 1D vector of the transformed minimum horizontal stress data for the depth interval of interest, the 1D vector of the transformed leakoff coefficient data for the depth interval of interest, and the 1D vector of the plane strain Young's modulus data for the depth interval of interest) may be taken as low-level features in three channels into the second convolutional neural network, such as a second U-Net. The predicted hydraulic fracture height from the first trained model (e.g., the fracture height above the perforation and the fracture height below the perforation) and the three scalars (e.g., the scalar of the fracture fluid pumping volume data, the scalar of the fracture fluid pumping rate data, and the scalar of fracturing fluid viscosity data) may be fed into the second convolutional neural network as high-level features at the bottleneck of the second convolutional neural network, such as at the bottleneck of the second U-Net. The simulation data (fracture geometry) may be fed into the second convolutional neural network as targets. The second trained model from the second convolutional neural network may be utilized to predict hydraulic fracture geometry, such as, predict hydraulic fracture geometry for a target hydraulic fracture.

The first convolutional neural network at 325 and the second convolutional neural network at 330 may be trained successively to predict hydraulic fracture height and fracture geometry, respectively. For example, the first U-Net at 325 and the second U-Net at 330 may be trained successively to predict hydraulic fracture height and hydraulic fracture geometry, respectively.

Optionally, at 321, the method 300 comprises splitting, before or after the transformation, the one-dimensional (1D) vector of the minimum horizontal stress data for the depth interval of interest into a plurality of one-dimensional (1D) vectors. The plurality of one-dimensional (1D) vectors is utilized for training the first model and training the second model.

Optionally, at 322, the method 300 comprises splitting, before or after the transformation, the one-dimensional (1D) vector of the leakoff coefficient data for the depth interval of interest into a plurality of one-dimensional (1D) vectors. The plurality of one-dimensional (1D) vectors is utilized for training the first model and training the second model.

Optionally, at 323, the method 300 comprises splitting the one-dimensional (1D) vector of the plane strain Young's modulus data for the depth interval of interest into a plurality of one-dimensional (1D) vectors. The plurality of one-dimensional (1D) vectors is utilized for training the first model and training the second model.

As explained in the context of 305, the original data may be obtained as three 1D vectors, and each of those 1D vectors may be kept as a 1D vector for training at 325 and at 330. Alternatively, the original data may be obtained as three 1D vectors, and each of those 1D vectors may be split into a plurality of 1D vectors (e.g., one 1D vector split into two 1D vectors). Although a split of a single 1D vector into two 1D vectors is discussed herein, some embodiments may potentially split a 1D vector into other even number of 1D vectors (e.g., 4, 6, 8, etc.). Moreover, the splitting can be done either before or after a transformation. The order of splitting and transformation should not impact the results.

Turning to a non-limiting example, let's assume that the minimum horizontal stress (before or after transformation) is provided in a 1D vector containing 200 elements. This example may include splitting/separating the single 1D vector by putting 1st-100th elements and 101th-200th elements into two 1D vectors. The same may be done for the 1D vector of leakoff coefficient (before or after transformation) and the 1D vector of the plane strain Young's modulus data. This example will result in six 1D vectors, each of which has 100 elements. As such, training the first convolutional neural network at 325 and training the second convolutional neural network at 330 may comprise using two 1D vectors of the minimum horizontal stress data for the depth interval of interest, two 1D vectors of the transformed leakoff coefficient data for the depth interval of interest, and two 1D vectors of the plane strain Young's modulus data for the depth interval of interest. These six 1D vectors may be taken as low-level features in six channels into the first convolutional neural network (e.g., the first U-Net) and the second convolutional neural network (e.g., the second U-Net). Again, although a split of a single 1D vector into two 1D vectors is discussed herein, some embodiments may potentially split a 1D vector into other even number of 1D vectors (e.g., 4, 6, 8, etc.). Moreover, the splitting can be done either before or after a transformation. The order of splitting and transformation should not impact the results.

At 335, the method 300 comprises obtaining target data for a target hydraulic fracture; determining a hydraulic fracture height for the target hydraulic fracture using the first trained model and the obtained target data for the target hydraulic fracture; and determining a hydraulic fracture geometry for the target hydraulic fracture using the second trained model, the obtained target data for the target hydraulic fracture, and the determined hydraulic fracture height for the target hydraulic fracture.

For example, the target data to determine hydraulic fracture height for the target hydraulic fracture may comprise fracture height above the perforation and the fracture height below the perforation. For example, the target data to determine hydraulic fracture geometry for the target hydraulic fracture may comprise the fracture length for the depth interval of interest (e.g., 1D vector which has the same element number as the other 1D vector inputs). For example, the target data may comprise information such as which wellbore, which stage, which cluster, etc. Some or all of the target data for the target hydraulic fracture may be user input from a user, such as via a graphical user interface. In short, the target data may comprise enough data about the target hydraulic fracture to be able to utilize the first trained model of 325 and the second trained model of 330.

At 340, the method comprises displaying the determined hydraulic fracture height for the target hydraulic fracture, the determined hydraulic fracture geometry for the target hydraulic fracture, or any combination thereof. Non-limiting examples of predicted/determined hydraulic fracture heights are illustrated in FIGS. 7A, 7B, and 7C. Non-limiting examples of predicted/determined hydraulic fracture geometries are illustrated in FIGS. 8A, 8B, and 8C. In some embodiments, 335 and/or 340 may be performed in a separate method.

If the subsurface formation 110 is substantially heterogeneous (e.g., based on a threshold or other methodologies in the art), then the method 300 may be performed a plurality of times for a plurality of target hydraulic fractures along a wellbore for more accurate results due to the heterogeneity. However, if the subsurface formation 110 is substantially homogeneous (e.g., based on a threshold or other methodologies in the art)), then the method 300 may be a performed a fewer number of times (potentially once for a single target hydraulic fracture along a wellbore) due to the homogeneity.

Advantageously, the computer output may be utilized to facilitate actions (e.g., in the context of drilling, hydraulic fracturing, etc.) in the subsurface formation, surface, or any combination thereof. One embodiment may include implementing or adjusting, based on the determined hydraulic fracture geometry for the target hydraulic fracture, a design parameter for a wellbore (same wellbore associated with well data utilized to train the first model and the second model or a different wellbore) of the subsurface formation. One embodiment may include implementing or adjusting, based on the determined hydraulic fracture geometry for the target hydraulic fracture, an operation parameter for a wellbore (same wellbore associated with well data utilized to train the first model and the second model or a different wellbore) of the subsurface formation. Design parameters may comprise well landing depth, well spacing in both lateral and vertical directions, cluster number in each stage, or any combination thereof. Operation parameters may comprise pumping volume, pumping rate, fracturing fluid viscosity, or any combination thereof.

EXAMPLES: Turning to FIGS. 7A-7C and 8A-8C, in these examples, a first trained model and a second trained model were tested with data from different zones than the training data (i.e., blind test). The hydraulic fracture geometries predicted by the second trained model utilizing the hydraulic fracture heights predicted by the first trained model showed good interpretability. The first trained model and the second trained model were trained successively using two U-Nets consistent with the instant disclosure.

FIG. 7A is an example consistent with the instant disclosure illustrating prediction versus simulation-based ground truth for a predicted hydraulic fracture height generated with the first trained model for a hydraulic fractureA. FIG. 8A is an example consistent with the instant disclosure illustrating prediction versus simulation-based ground truth for a predicted hydraulic fracture geometry generated with the second trained model utilizing the predicted hydraulic fracture height generated with the first trained model in FIG. 7A for the hydraulic fractureA.

FIG. 7B is an example consistent with the instant disclosure illustrating prediction versus simulation-based ground truth for a predicted hydraulic fracture height generated with the first trained model for a hydraulic fractureB. FIG. 8B is an example consistent with the instant disclosure illustrating prediction versus simulation-based ground truth for a predicted hydraulic fracture geometry generated with the second trained model utilizing the predicted hydraulic fracture height generated with the first trained model in FIG. 7B for the hydraulic fractureB.

FIG. 7C is an example consistent with the instant disclosure illustrating prediction versus simulation-based ground truth for a predicted hydraulic fracture height generated with the first trained model for a hydraulic fractureC. FIG. 8C is an example consistent with the instant disclosure illustrating prediction versus simulation-based ground truth for a predicted hydraulic fracture geometry generated with the second trained model utilizing the predicted hydraulic fracture height generated with the first trained model in FIG. 7C for the hydraulic fractureC.

In these blind tests, FIGS. 7A, 7B, and 7C illustrate good correspondence between the hydraulic fracture height predictions and the simulation-based ground truths for the hydraulic fractureA, the hydraulic fractureB, and the hydraulic fractureC. In addition to the good correspondence between predictions and ground truths, FIGS. 7A, 7B, and 7C also lead to the finding that the predicted hydraulic fracture heights are well constrained by high stress layers above and below the perforation, which makes physical sense. This also indicates that the first trained model has good accuracy and may capture the first principles behind the full-order fracturing simulators.

In these blind tests, FIGS. 8A, 8B, and 8C illustrate good correspondence between the fracture geometry predictions and the simulation-based ground truths for the hydraulic fractureA, the hydraulic fractureB, and the hydraulic fractureC. In addition to the good correspondence between predictions and ground truths, FIGS. 8A, 8B, and 8C also lead to the finding that fracture lengths are pinched in the high-stress layers that the hydraulic fractures are able to break through, forming fingering fracture fronts. This also demonstrates that the second trained model is able to capture the first principles behind the full-order fracturing simulators and provide physically reasonable outputs.

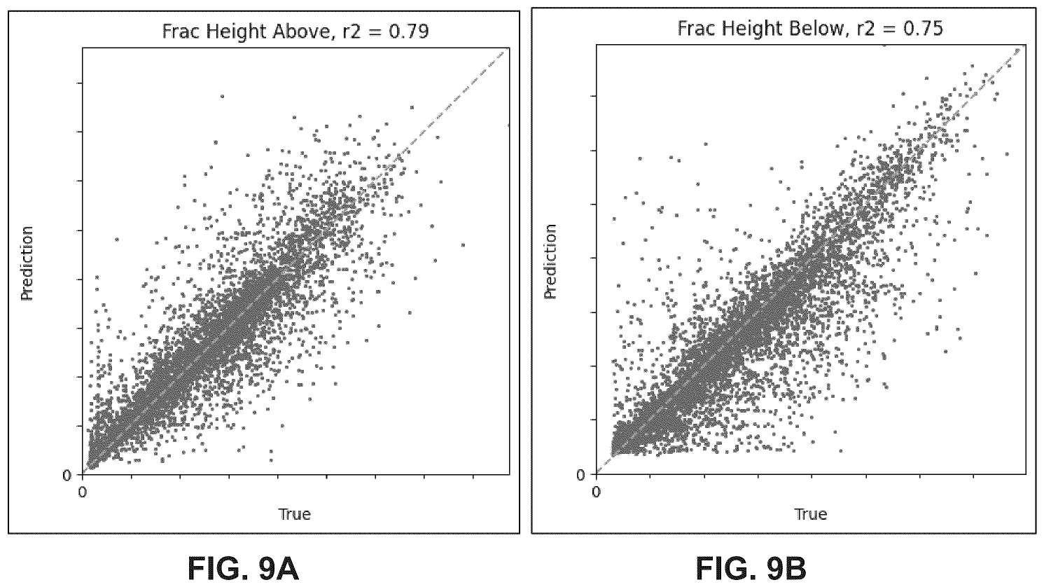

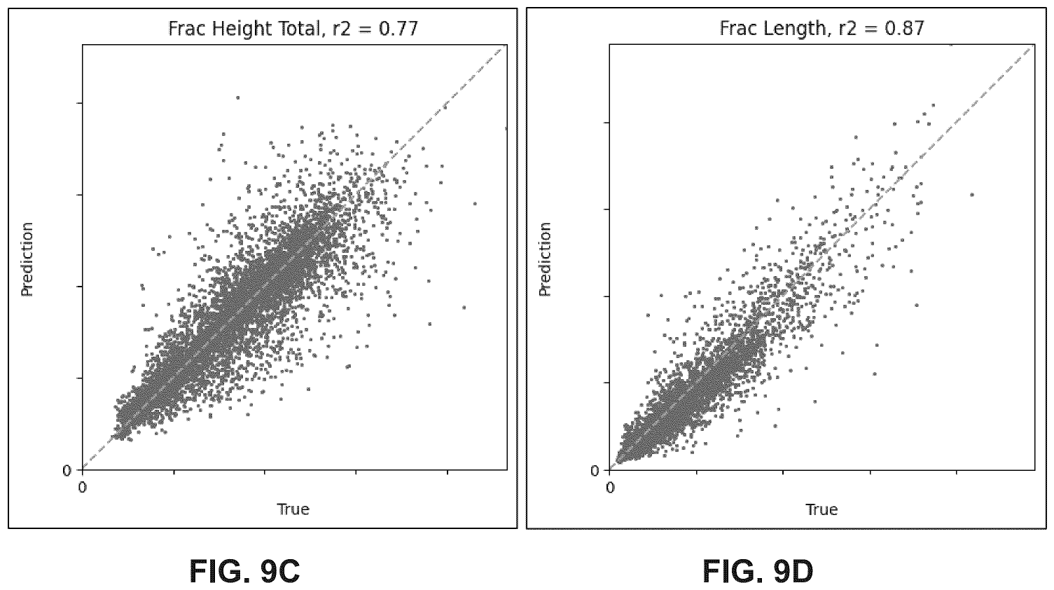

FIG. 9A is an example consistent with the instant disclosure in which a coefficient of determination (R2) between predictions and simulation-based ground truths is higher than 0.7 for hydraulic fracture height above the perforation. FIG. 9B is an example consistent with the instant disclosure in which a coefficient of determination (R2) between predictions and simulation-based ground truths is higher than 0.7 for hydraulic fracture height below the perforation. FIG. 9C is an example consistent with the instant disclosure in which a coefficient of determination (R2) between predictions and simulation-based ground truths is higher than 0.7 for hydraulic fracture height total. FIG. 9D is an example consistent with the instant disclosure in which a coefficient of determination (R2) between predictions and simulation-based ground truths is higher than 0.7 for hydraulic fracture length.

FIGS. 9A, 9B, 9C, and 9D illustrate comparisons (blind tests) for thousands of cases, which indicate reasonable match between predictions and simulation-based ground truths for both predicted hydraulic fracture heights and predicted fracture geometries. This indicates that the good correspondence seen in FIGS. 7A-7C and FIGS. 8A-8C is not an exception for the three hydraulic fractureA-hydraulic fractureC, but a generalized observation.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of +10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

Unless defined otherwise, all technical and scientific terms used herein have the same meanings as commonly understood by one of skill in the art to which the disclosed invention belongs. All citations referred herein are expressly incorporated by reference.

Although some of the various drawings illustrate a number of logical stages in a particular order, logical stages that are not order dependent may be reordered and other logical stages may be combined or broken out. While some reordering or other groupings are specifically mentioned, others will be obvious to those of ordinary skill in the art and so do not present an exhaustive list of alternatives. Moreover, it should be recognized that the logical stages could be implemented in hardware, firmware, software, or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of determining hydraulic fracture geometry, the method comprising:
obtaining data for a subsurface formation, wherein the obtained data comprises horizontal minimum stress data for a depth interval of interest, leakoff coefficient data for the depth interval of interest, plane strain Young's modulus data for the depth interval of interest, fracture fluid pumping volume data, fracture fluid pumping rate data, and fracturing fluid viscosity data;
generating hydraulic fracturing simulation data by running a plurality of hydraulic fracturing simulations using the minimum horizontal stress data for the depth interval of interest, the leakoff coefficient data for the depth interval of interest, the plane strain Young's modulus data for the depth interval of interest, the fracture fluid pumping volume data, the fracture fluid pumping rate data, and the fracturing fluid viscosity data, wherein the hydraulic fracturing simulation data comprises a plurality of simulated fracture heights and a plurality of fracture geometries;
transforming the minimum horizontal stress data for a depth interval of interest into transformed minimum horizontal stress data by removing minimum horizontal stress at a perforation and removing hydrostatic pressure;
transforming the leakoff coefficient data into transformed leakoff coefficient data by performing a logarithm transformation;
training a first model that predicts a hydraulic fracture height for a hydraulic fracture using a first convolution neural network, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data; and
training a second model that predicts a hydraulic fracture geometry for the hydraulic fracture using a second convolution neural network, the predicted hydraulic fracture height from the first trained model, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data.

2. The method of claim 1, wherein a one-dimensional (1D) vector is utilized to obtain the minimum horizontal stress data, a one-dimensional (1D) vector is utilized to obtain the leakoff coefficient, and a one-dimensional (1D) vector is utilized to obtain the plane strain Young's modulus data.

3. The method of claim 2, further comprising splitting, before or after the transformation, the one-dimensional (1D) vector of the minimum horizontal stress data for the depth interval of interest into a plurality of one-dimensional (1D) vectors, wherein the plurality of one-dimensional (1D) vectors is utilized for training the first model and training the second model.

4. The method of claim 2, further comprising splitting, before or after the transformation, the one-dimensional (1D) vector of the leakoff coefficient data for the depth interval of interest into a plurality of one-dimensional (1D) vectors, wherein the plurality of one-dimensional (1D) vectors is utilized for training the first model and training the second model.

5. The method of claim 2, further comprising splitting the one-dimensional (1D) vector of the plane strain Young's modulus data for the depth interval of interest into a plurality of one-dimensional (1D) vectors, wherein the plurality of one-dimensional (1D) vectors is utilized for training the first model and training the second model.

6. The method of claim 1, wherein a scalar is utilized to obtain the fracture fluid pumping volume data, a scalar is utilized to obtain the fracture fluid pumping rate data, and a scalar is utilized to obtain the fracturing fluid viscosity data.

7. The method of claim 1, wherein the first convolutional neural network comprises a first U-Net.

8. The method of claim 1, wherein the second convolutional neural network comprises a second U-Net.

9. The method of claim 1, wherein the transformed minimum horizontal stress data for the depth interval of interest, the transformed leakoff coefficient data for the depth interval of interest, the plane strain Young's modulus data for the depth interval of interest are utilized as low-level features in the first convolutional neural network and the second convolutional neural network.

10. The method of claim 1, wherein the fracture fluid pumping volume data, the fracture fluid pumping rate data, and the fracturing fluid viscosity data are utilized as high-level features at a bottleneck of the first convolutional neural network and the second convolutional neural network.

11. The method of claim 1, wherein the predicted hydraulic fracture height from the first trained model is utilized as a high-level feature at a bottleneck of the second convolutional neural network.

12. The method of claim 1, further comprising:
obtaining target data for a target hydraulic fracture;
determining a hydraulic fracture height for the target hydraulic fracture using the first trained model and the obtained target data for the target hydraulic fracture; and
determining a hydraulic fracture geometry for the target hydraulic fracture using the second trained model, the obtained target data for the target hydraulic fracture, and the determined hydraulic fracture height for the target hydraulic fracture.

13. A computer system, comprising:
one or more processors;
memory; and
one or more programs, wherein the one or more programs are stored in the memory and configured to be executed by the one or more processors, the one or more programs including instructions that when executed by the one or more processors cause the system to determine hydraulic fracture geometry, the method comprising:
obtaining data for a subsurface formation, wherein the obtained data comprises horizontal minimum stress data for a depth interval of interest, leakoff coefficient data for the depth interval of interest, plane strain Young's modulus data for the depth interval of interest, fracture fluid pumping volume data, fracture fluid pumping rate data, and fracturing fluid viscosity data;
generating hydraulic fracturing simulation data by running a plurality of hydraulic fracturing simulations using the minimum horizontal stress data for the depth interval of interest, the leakoff coefficient data for the depth interval of interest, the plane strain Young's modulus data for the depth interval of interest, the fracture fluid pumping volume data, the fracture fluid pumping rate data, and the fracturing fluid viscosity data, wherein the hydraulic fracturing simulation data comprises a plurality of simulated fracture heights and a plurality of fracture geometries;
transforming the minimum horizontal stress data for a depth interval of interest into transformed minimum horizontal stress data by removing minimum horizontal stress at a perforation and removing hydrostatic pressure;
transforming the leakoff coefficient data into transformed leakoff coefficient data by performing a logarithm transformation;
training a first model that predicts a hydraulic fracture height for a hydraulic fracture using a first convolution neural network, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data; and
training a second model that predicts a hydraulic fracture geometry for the hydraulic fracture using a second convolution neural network, the predicted hydraulic fracture height from the first trained model, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data.

14. The system of claim 13, wherein a one-dimensional (1D) vector is utilized to obtain the minimum horizontal stress data, a one-dimensional (1D) vector is utilized to obtain the leakoff coefficient, and a one-dimensional (1D) vector is utilized to obtain the plane strain Young's modulus data.

15. The system of claim 14, wherein the one or more programs include instructions that when executed by the one or more processors cause the system to split, before or after the transformation, the one-dimensional (1D) vector of the minimum horizontal stress data for the depth interval of interest into a plurality of one-dimensional (1D) vectors, wherein the plurality of one-dimensional (1D) vectors is utilized for training the first model and training the second model.

16. The system of claim 14, wherein the one or more programs include instructions that when executed by the one or more processors cause the system to split, before or after the transformation, the one-dimensional (1D) vector of the leakoff coefficient data for the depth interval of interest into a plurality of one-dimensional (1D) vectors, wherein the plurality of one-dimensional (1D) vectors is utilized for training the first model and training the second model.

17. The system of claim 14, wherein the one or more programs include instructions that when executed by the one or more processors cause the system to split the one-dimensional (1D) vector of the plane strain Young's modulus data for the depth interval of interest into a plurality of one-dimensional (1D) vectors, wherein the plurality of one-dimensional (1D) vectors is utilized for training the first model and training the second model.

18. The system of claim 13, wherein a scalar is utilized to obtain the fracture fluid pumping volume data, a scalar is utilized to obtain the fracture fluid pumping rate data, and a scalar is utilized to obtain the fracturing fluid viscosity data.

19. The system of claim 13, wherein the first convolutional neural network comprises a first U-Net.

20. The system of claim 13, wherein the second convolutional neural network comprises a second U-Net.

21. The system of claim 13, wherein the transformed minimum horizontal stress data for the depth interval of interest, the transformed leakoff coefficient data for the depth interval of interest, the plane strain Young's modulus data for the depth interval of interest are utilized as low-level features in the first convolutional neural network and the second convolutional neural network.

22. The system of claim 13, wherein the fracture fluid pumping volume data, the fracture fluid pumping rate data, and the fracturing fluid viscosity data are utilized as high-level features at a bottleneck of the first convolutional neural network and the second convolutional neural network.

23. The system of claim 13, wherein the predicted hydraulic fracture height from the first trained model is utilized as a high-level feature at a bottleneck of the second convolutional neural network.

24. The system of claim 13, wherein the one or more programs include instructions that when executed by the one or more processors cause the system to:
obtain target data for a target hydraulic fracture;
determine a hydraulic fracture height for the target hydraulic fracture using the first trained model and the obtained target data for the target hydraulic fracture; and
determine a hydraulic fracture geometry for the target hydraulic fracture using the second trained model, the obtained target data for the target hydraulic fracture, and the determined hydraulic fracture height for the target hydraulic fracture.

25. A method of determining hydraulic fracture geometry, the method comprising:
obtain target data for a target hydraulic fracture;
determine a hydraulic fracture height for the target hydraulic fracture using a first trained model and the obtained target data for the target hydraulic fracture; and
determine a hydraulic fracture geometry for the target hydraulic fracture using a first trained model, the obtained target data for the target hydraulic fracture, and the determined hydraulic fracture height for the target hydraulic fracture;
wherein the first trained model and the second trained model are trained as follows:
obtaining data for the subsurface formation, wherein the obtained data comprises horizontal minimum stress data for a depth interval of interest, leakoff coefficient data for the depth interval of interest, plane strain Young's modulus data for the depth interval of interest, fracture fluid pumping volume data, fracture fluid pumping rate data, and fracturing fluid viscosity data;
generating hydraulic fracturing simulation data by running a plurality of hydraulic fracturing simulations using the minimum horizontal stress data for the depth interval of interest, the leakoff coefficient data for the depth interval of interest, the plane strain Young's modulus data for the depth interval of interest, the fracture fluid pumping volume data, the fracture fluid pumping rate data, and the fracturing fluid viscosity data, wherein the hydraulic fracturing simulation data comprises a plurality of simulated fracture heights and a plurality of fracture geometries;
transforming the minimum horizontal stress data for a depth interval of interest into transformed minimum horizontal stress data by removing minimum horizontal stress at a perforation and removing hydrostatic pressure;
transforming the leakoff coefficient data into transformed leakoff coefficient data by performing a logarithm transformation;
training the first model that predicts a hydraulic fracture height for a hydraulic fracture using a first convolution neural network, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data; and
training the second model that predicts a hydraulic fracture geometry for the hydraulic fracture using a second convolution neural network, the predicted hydraulic fracture height from the first trained model, the hydraulic fracturing simulation data, the transformed minimum horizontal stress data for the depth interval of interest, the transformed leakoff coefficient data for the depth interval of interest, the plane strain Young's modulus data for the depth interval of interest, the fracture fluid pumping volume data, the fracture fluid pumping rate data, and the fracturing fluid viscosity data.
